(19) United States
(12) Patent Application Publication
(10) Pub. No.: US 2026/0170486 A1
(43) Pub. Date: Jun. 18, 2026

(54) SECURE TOKEN PREMINTING IN BLOCKCHAIN SYSTEMS

(71) Applicant: Circle Internet Group, Inc., New York, NY (US)

(72) Inventors: Khalid ALIWEH, Boston, MA (US); Tamas HENNING, Boston, MA (US)

(21) Appl. No.: 19/536,308

(22) Filed: Feb. 11, 2026

Related U.S. Application Data
(63) Continuation of application No. 19/060,040, filed on Feb. 21, 2025.
(60) Provisional application No. 63/631,874, filed on Apr. 9, 2024.

(51) Int. Cl. G06Q 20/36; G06Q 20/10; G06Q 20/40

(52) U.S. Cl. CPC G06Q 20/3678; G06Q 20/10; G06Q 20/405; G06Q 2220/00

(57) ABSTRACT

Certain aspects of the present disclosure provide techniques for securely minting and distributing tokens on a blockchain. An example method generally includes configuring, by an owner of a token deployed on a blockchain, a premint wallet smart contract associated with a token preminter that generates preminted tokens for the token. The token preminter and premint token spenders are configured by the owner of the premint wallet smart contract. A plurality of tokens are minted by the token preminter to the premint wallet. At one of the premint token spenders, a request to spend an amount of preminted tokens from the premint wallet is received. The requested amount of preminted tokens is compared to a spending allowance defined for the token premint spender, and based on the comparing, the requested amount of preminted tokens are transferred by the token premint spender from a premint wallet to a destination wallet.

### CROSS-REFERENCE TO RELATED APPLICATIONS

This application is a continuation of U.S. patent application Ser. No. 19/060,040, filed Feb. 21, 2025, which claims benefit of U.S. provisional patent application Ser. No. 63/631,874, filed Apr. 9, 2024, both of which are herein incorporated by reference.

### INTRODUCTION

Aspects of the present disclosure relate to security in blockchain systems, and more specifically to securely minting tokens in blockchain systems.

### BACKGROUND

Blockchains can be used in various decentralized systems to provide a ledger of transactions that have occurred within these decentralized systems. Generally, a blockchain may include a chain of blocks, in which latest block includes some information about a transaction that occurred and a reference to an immediate predecessor block, which may be a hashed value of the previous block. Because the reference to the immediate predecessor block may be a value derived from the immediate predecessor block, verification of the transactions in the blockchain may be performed by ensuring that a hash of a block resolves to the same value as that stored as a reference to the immediate predecessor block in a succeeding block in the blockchain. If there is a mismatch between a computed hash of a block and the hashed value of the block in a succeeding block in the blockchain, validation of the blockchain may fail.

Blockchains generally allow for transactions to be performed using a variety of tokens which can be minted in various manners. For some tokens, such as stablecoins or other tokens which have value derived from some other asset (e.g., fiat currency, real-world assets, etc. for asset-backed stablecoins, other digital tokens for algorithmic stablecoins, etc.), tokens may be minted when the other assets backing these tokens are deposited, created, or otherwise made available to back the value of these tokens. In another example, for tokens which exist independently of other assets, tokens may be minted in various manners, such as upon verifying transactions on the blockchain, on an arbitrary schedule, or the like. Regardless of how tokens are minted, token minting may be a process which may be exploited. For example, if a malicious user obtains access rights to a token minter, the malicious user can generate tokens outside of the regular course by which these tokens are generated. Thus, a malicious user can generate an unlimited amount of tokens which can diminish the value of the token and thus diminish the security of a blockchain system in which tokens are used.

Accordingly, techniques are needed to allow for secure minting of tokens in blockchain systems.

### BRIEF SUMMARY

Certain embodiments provide a computer-implemented method for minting tokens on a blockchain. An example method generally includes configuring, by an owner of a token deployed on a blockchain, a premint wallet smart contract associated with a token preminter that generates preminted tokens for the token deployed on the blockchain. The token preminter is configured as a token minter by an owner of the premint wallet smart contract, and one or more premint token spenders to spend preminted tokens from the premint wallet are configured by the owner of the premint wallet smart contract. A plurality of tokens are minted by the token preminter to the premint wallet. At one of the one or more premint token spenders, a request to spend an amount of preminted tokens from the premint wallet is received. The requested amount of preminted tokens is compared to a spending allowance defined for the token premint spender, and based on the comparing indicating that the requested amount of preminted tokens is less than the spending allowance defined for the token premint spender, the requested amount of preminted tokens are transferred by the token premint spender from a premint wallet to a destination wallet on a blockchain.

Certain embodiments provide a computer-implemented method for preminting tokens on a blockchain for future deployment on the blockchain. An example method generally includes configuring a token preminter as a token minter, the token preminter being associated with a premint wallet. One or more premint token spenders are configured to spend preminted tokens from the premint wallet. A plurality of tokens are minted to the premint wallet and made spendable on a blockchain by the one or more premint token spenders.

Certain embodiments provide a computer-implemented method for spending preminted tokens on a blockchain. An example method generally includes receiving a request to spend an amount of preminted tokens from a premint wallet. The requested amount of preminted tokens is compared to a spending allowance defined for a token premint spender. Based on the comparing indicating that the requested amount of preminted tokens is less than the spending allowance defined for the token premint spender, the requested amount of preminted tokens are transferred from a premint wallet to a destination wallet on a blockchain.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment in which tokens are securely preminted and spent on a blockchain, according to aspects of the present disclosure.

FIG. 2 illustrates example operations for securely preminting and spending tokens on a blockchain, according to aspects of the present disclosure.

FIG. 3 illustrates example operations for configuring and using a preminter to securely premint tokens on a blockchain, according to aspects of the present disclosure.

FIG. 4 illustrates example operations for securely spending preminted tokens on a blockchain, according to aspects of the present disclosure.

FIG. 5 illustrates an example system on which embodiments of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Transactions in cryptocurrency systems may be represented as blocks in a blockchain that track a universe of transactions performed using the cryptocurrency system. These transactions may be performed using a variety of tokens; a first party to a transaction may send a quantity of tokens to second party to the transaction, and in exchange, the second party to the transaction may send a digital and/or physical asset to the first party of the transaction. In these cryptocurrency systems, processed transactions may not be modified at a later date, thus providing an immutable ledger of the transactions performed using the cryptocurrency system.

Generally, tokens used in performing transactions on a blockchain need to exist on the blockchain before such transactions are performed. To generate tokens on the blockchain, a process also known as minting, a minting authority or other minting mechanism may be used to generate new tokens and distribute these tokens to one or more wallets on the blockchain based on a variety of triggering conditions. For example, for tokens backed by real-world assets, such tokens may be generated when a real-world asset is received by the minting authority. Tokens may not be generated until corresponding real-world assets are received by the minting authority, as doing so may diminish the value of the tokens due to an imbalance between extant tokens on the blockchain and the real-world assets backing the tokens on the blockchain. For other types of tokens, such tokens may be generated when a triggering event occurs; for example, tokens may be minted and rewarded to a user on the blockchain when the user performs a specified action, such as the verification of other transactions on the blockchain.

In some cases, tokens may be preminted before such tokens are distributed to users on the blockchain. In preminting tokens, tokens that are not backed by real-world assets or have been generated even though no triggering event has occurred may be speculatively minted prior to the receipt of such real-world assets or the occurrence of a triggering event that would cause tokens to be minted and distributed to one or more designated wallets on the blockchain. Generally, a token preminter may be a monolithic construct that premints tokens prior to the receipt of real-world assets or the occurrence of a triggering event and subsequently issues the pre-minted tokens to one or more defined destination wallets. Because of the monolithic nature of a token preminter, compromising the preminter or the premint wallet may introduce security vulnerabilities in the blockchain. For example, if the token preminter is compromised by a malicious party, the malicious party could release preminted tokens from a premint wallet to other wallets on the blockchain independently of the receipt of real-world assets to back the preminted tokens or independently of the occurrence of some other triggering event that would typically cause these tokens to be issued to one or more users with wallets on the blockchain. Thus, a malicious party could dilute the value of tokens in the blockchain by compromising a token preminter, which may reduce trust in the token itself and token issuers on the blockchain.

Aspects of the present disclosure provide techniques for improving the security of token preminting on the blockchain by distributing token preminting and token spending across different entities on the blockchain. To distribute token preminting and token spending across different entities on the blockchain, a token owner, a preminter, and one or more token spenders may control portions of the token preminting process but may not control the entire preminting process. For example, a token owner can configure one or more token preminters that speculatively mint tokens prior to the receipt of corresponding real-world assets by the token owner or the occurrence of defined token issuing events. The token preminters may configure one or more token spenders which distribute preminted tokens to one or more defined recipient addresses; however, the token preminters may not distribute the preminted tokens. Meanwhile, the one or more token spenders may be configured to distribute preminted tokens up to a defined amount for each of the one or more token spenders. When a token spender has distributed its defined amount of tokens, the token spender may not be allowed to distribute any further preminted tokens until the token spender's allowance is reset to a non-zero, non-negative amount. By distributing token preminting and token spending across different entities, aspects of the present disclosure may improve the security of blockchain systems by preventing malicious users from compromising the security of a token on the blockchain by compromising a single token minting authority. For example, if a token preminter is compromised, an unlimited amount of tokens may be preminted, but because preminted tokens in a premint wallet can only be distributed by defined premint spenders, these preminted tokens may not be able to be distributed to other addresses on the blockchain. Meanwhile, if a token spender is compromised, only a limited amount of tokens may be distributed to other wallets until reaching the token allowance allocated to the compromised token spender, which may limit the effect of a compromised token spender on the value of a token on the blockchain.

### Example Secure Preminting of Tokens on a Blockchain Using Distributed Token Preminting and Spending

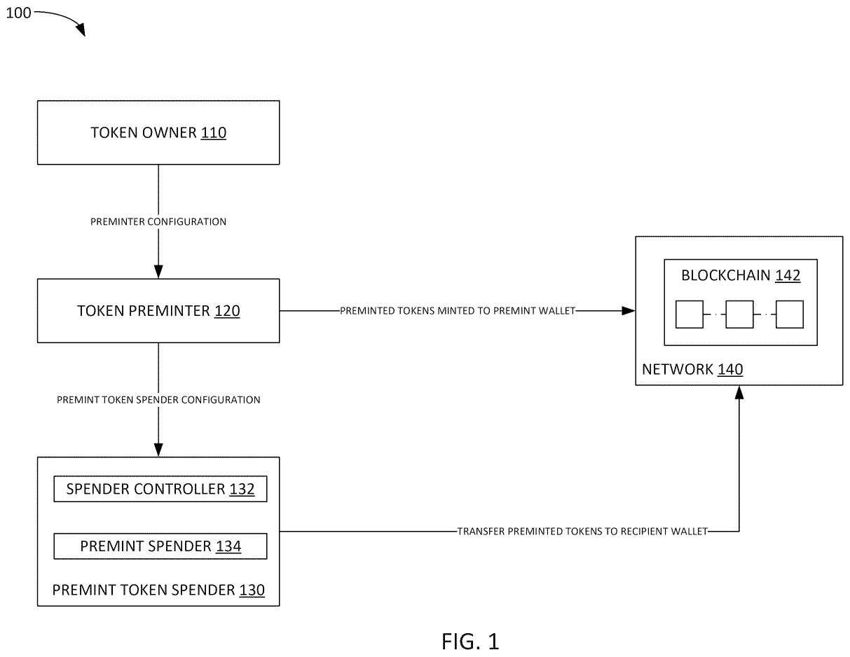

FIG. 1 illustrates an example computing environment 100 in which tokens are securely preminted and spent on a blockchain, according to aspects of the present disclosure. As illustrated, computing environment 100 includes a token owner 110, a token preminter 120, a premint token spender 130, and a network 140.

The token owner 110 generally represents a computing resource which maintains responsible for or otherwise controls the issuance of a token on a blockchain (e.g., the blockchain 142 illustrated in FIG. 1). Generally, the token owner 110 may be a resource which owns a smart contract that defines the minting of tokens on the blockchain. To coordinate secure preminting of tokens on a blockchain using distributed token preminting and spending, which, as discussed, may prevent the compromise of a single role in the distributed system from allowing for the unlimited minting of tokens on the blockchain, the token owner 110 generally configures a premint wallet smart contract as a token minter. The premint wallet smart contract may be configured with an infinite allowance so that a supply of tokens can be minted (and, in some aspects, burned) on an as-needed basis. For example, a supply of preminted tokens may be maintained to allow for the issuance of tokens when various triggering events defined by the token owner 110 occur (e.g., receipt of real-world assets backing the value of a stablecoin token, the occurrence of an issuance event such as completion of a computing task, etc.). In a stablecoin deployment in which tokens are issued upon receipt by the token owner 110 of corresponding real-world assets, preminted tokens can be removed from a premint wallet (as discussed in further detail herein) and transferred to a destination wallet, which reduces the number of preminted tokens which are available for issuance. When the amount of preminted tokens reaches a threshold level, the token preminter 120 can premint additional tokens for future distribution when a triggering event occurs.

Generally, the premint wallet smart contract may define a premint wallet into which preminted tokens are deposited upon preminting by the token preminter 120 and out of which tokens are withdrawn by a premint token spender 130. To ensure the security of token issuances performed in the computing environment 100, the premint wallet smart contract may restrict the addresses from which tokens can be received. For example, the premint wallet smart contract may be configured by the token owner 110 with a plurality of source addresses on an allowlist of addresses from which the premint wallet can accept newly preminted tokens. The plurality of source addresses may include, for example, an address associated with a token smart contract owned or otherwise controlled by the token owner 110. By doing so, the premint wallet smart contract may be restricted to allowing the deposit of preminted tokens from sources owned by the token owner 110 and may not accept tokens or other digital assets from sources other than those included in the allowlist of addresses. Further, in some aspects, the premint wallet smart contract may be configured such that the premint wallet is allowed to receive a specified type of token but may not receive tokens other than the specified type of token (e.g., tokens native to the blockchain 142, etc.).

In some aspects, the premint wallet smart contract may further be configured with a destination wallet allowlist. The destination wallet allowlist generally identifies addresses to which preminted wallets can be distributed by the premint token spender 130. The addresses on the destination wallet allowlist may, in some aspects, be defined by the token owner 110 and correspond to wallet addresses owned by the token owner 110. For example, the addresses on the destination wallet allowlist may be addresses associated with one or more reserve wallets into which minted tokens are initially distributed and which are associated with corresponding repositories in which real-world assets corresponding to minted tokens are deposited.

The token preminter 120 generally represents a computing resource which may be configured to mint tokens to and burn tokens from a premint wallet on the blockchain 142. Generally, the token preminter 120 may be configured by the owner of the premint wallet on the blockchain 142 to allow for the minting and burning of preminted tokens on an as-needed basis. To mint tokens, the token preminter 120 can execute a token minting function on the premint wallet smart contract defining the premint wallet into which preminted tokens are deposited. This mint function may, in some aspects, in turn invoke a token minting function on a token smart contract owned by the token owner 110 which mints tokens and deposits the minted tokens into the premint wallet. After the tokens are minted and deposited, the extant balance of tokens in the premint wallet may be updated to reflect the deposit of the newly minted tokens into the premint wallet.

The token preminter 120 may configure one or more preminted token spenders 130 to distribute preminted tokens to defined destination wallets on the blockchain 142. Generally, in configuring the one or more preminted token spenders 130, the token preminter 120 may configure a spender controller 132 and a wallet address on the blockchain 142 associated with the premint token spender 130. The configuration of the spender controller may, in some aspects, include generating an address associated with the premint token spender 130 (e.g., an address of the premint spender 134) which can, upon detecting the occurrence of a triggering event, initiate a transfer of tokens from a premint wallet on the blockchain 142 to another wallet on the blockchain 142.

The premint token spender 130 generally represents a computing resource which may be configured to spend tokens out of the premint wallet on the blockchain 142 to effectuate the issuance of tokens upon the occurrence of a triggering event defined for the token. For example, as discussed above, a triggering event for a stablecoin or other token backed by real-world and/or other digital assets may include the receipt of such real-world and/or digital assets from a party who wishes to obtain the corresponding tokens for these real-world and/or digital assets. In another example, a triggering event for a token that exists independently of a real-world and/or digital asset may include, for example, the occurrence of an event, such as the completion of a computational task, that triggers the issuance of a token.

As illustrated, the premint token spender 130 includes a spender controller 132 and a premint spender 134. The spender controller 132 generally configures the premint spender 134 to spend tokens from the premint wallet on the blockchain 142 when a triggering event occurs. To configure the premint spender 134, the spender controller 132 can provide the premint spender 134 with a spending allowance and one or more destination wallet addresses on an allowlist. The spending allowance generally identifies an amount of preminted tokens which the premint spender 134 can spend from the premint wallet on the blockchain 142. The spending allowance may, in some aspects, be set based on a number of premint token spenders 130 that are configured by the token preminter 120, a volume of mint transactions performed across different regions associated with different premint token spenders 130, and/or other factors which may influence the appropriate allowance for any given premint token spender 130 in the computing environment 100. The spender controller 132 may identify the destination wallet addresses on the allowlist for the premint token spender 130, for example, based on a geographic region in which the premint token spender 130 operates, based on a distribution of real-world and/or digital assets across different custodians (with each premint token spender 130 being associated with a different custodian), or the like.

To mint tokens on the blockchain 142 and place these tokens into distribution, the premint spender 134 may monitor for the occurrence of a triggering event or a notification received from another source that such a triggering event has occurred. When a triggering event has occurred, the premint spender 134 can invoke a token spending function in the premint wallet smart contract associated with the premint wallet out of which tokens are spent by the premint spender 134. The token spending function generally effectuates the transfer of tokens from the premint wallet to a destination wallet which may be identified by the premint spender 134.

In some aspects, the premint spender 134 and the token spending function in the premint wallet smart contract associated with the premint wallet out of which tokens are spent by the premint spender 134 may perform various checks to determine whether a spend request received at the premint token spender 130 is valid and can be satisfied by the premint spender 134. For example, the premint spender 134 and the token spending function may examine a specified destination address in a request to spend tokens out of the premint wallet to addresses included in the allowlist of addresses to which preminted tokens can be spent. If the specified destination address is not included in the allowlist of addresses, the premint spender 134 can decline to satisfy the request to spend tokens. If, however, the specified address is included in the allowlist of addresses, the premint spender 134 can spend tokens out of the premint wallet to the specified destination address, subject to limits on an amount of a spending allowance remaining for the premint spender 134.

As discussed, the spending allowance with which the premint spender 134 is configured may impose a limit on the amount of preminted tokens which the premint spender 134 can transfer from a premint wallet to a destination wallet on the blockchain 142. Generally, the spending allowance may be adjusted downward as issuance transactions are performed by the premint spender 134 (e.g., in response to the occurrence of various triggering events). When the spending allowance reaches zero, the premint spender 134 may not be used to transfer tokens from the premint wallet to a destination wallet on the blockchain 142 until the spending allowance is manually reset (e.g., by the token owner 110, an owner of the token preminter 120, etc.). Generally, by not allowing for automatic replenishment of the spending allowance, aspects of the present disclosure may prevent a compromised premint spender 134 from transferring an unlimited amount of tokens from a premint wallet to a destination wallet on the blockchain 142.

When the spending allowance remaining for the premint spender 134 is greater than a specified amount in a request to spend tokens received at the premint token spender 130, the premint token spender 130 can effectuate the transfer of tokens from the premint wallet to the specified destination wallet (subject in some aspects, as discussed above, to verification of the address of the destination wallet). When, however, the remaining spending allowance for the premint spender 134 is less than the specified amount in the request to spend tokens received at the premint token spender 130, various techniques may be used to handle the request. In one aspect, the request may be rejected by the premint spender 134. In such a case, the request may be automatically forwarded or otherwise routed to another premint token spender 130 for processing, or a failure notification may be output by the premint spender 134 to the origin device from which the request is received. In another example, the request may be bifurcated into two portions: a first portion corresponding to the remaining spending allowance for the premint spender 134, and a second portion corresponding to the difference between the specified amount in the request and the remaining spending allowance for the premint spender 134. The first portion may be satisfied by the premint spender 134. The premint spender 134 may, in some aspects, automatically forward or otherwise route the second portion to another premint token spender 130 for processing. After the tokens are spent by the premint spender 134, the tokens may be considered to be validly issued and may be used to perform various transactions on the blockchain 142. These tokens may be transferred from any address on the blockchain 142, including addresses associated with reserve accounts maintained by the token owner 110 for the token, to any other address on the blockchain 142 corresponding to a wallet or other repository into which tokens may be deposited and from which tokens may be withdrawn.

The network 140 may, in some aspects, be a cryptocurrency network for which the token owner 110, the token preminter 120, and the premint token spender 130 mints tokens for use in performing various transactions on the network. By way of example, network 140 may be a network such as ALGORAND™, BITCOIN™, ETHEREUM®, SOLANA™, STELLAR™, TRON™, and other cryptocurrency networks. Transactions on a blockchain 142 hosted by network 140 may include, for example, the execution of one or more smart contracts on the blockchain 142 or by the generation of one or more blocks on the blockchain evidencing the occurrence of a transaction on the blockchain 142.

### Example Operations for Secure Preminting of Tokens on a Blockchain Using Distributed Token Preminting and Spending

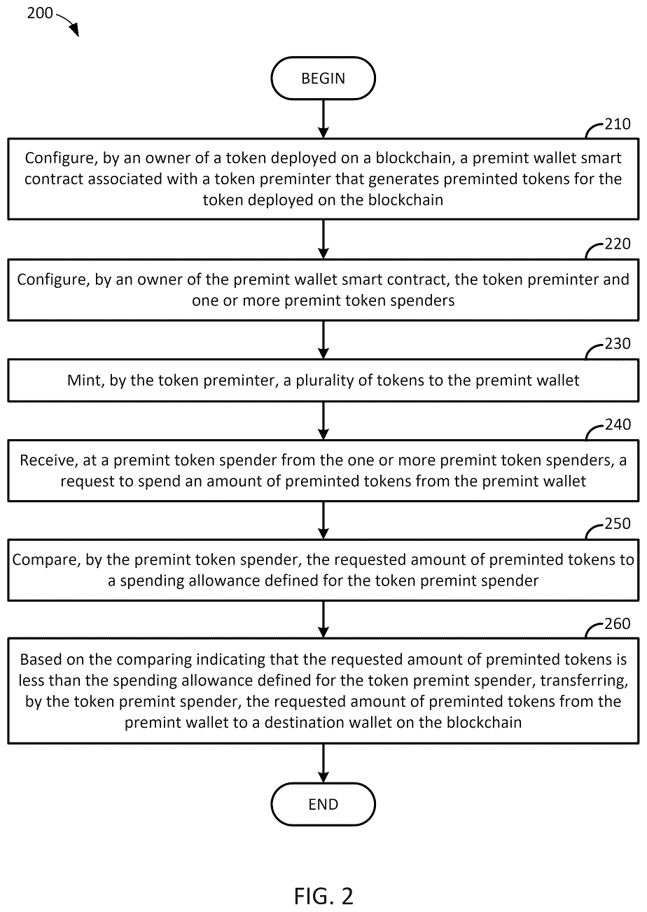

FIG. 2 illustrates example operations 200 for securely preminting and spending tokens on a blockchain, according to aspects of the present disclosure. The operations 200 may be performed, for example, by the token owner 110, the token preminter 120, and the premint token spender 130 illustrated in FIG. 1 or other computing devices on which roles for preminting and spending tokens can be distributed across different access-controlled computing resources.

As illustrated, the operations 200 begin at block 210 with the owner of a token deployed on a blockchain configuring a premint wallet smart contract. The premint wallet smart contract is generally associated with a token preminter that generates preminted tokens for the token deployed on the blockchain.

At block 220, the operations 200 proceed with the owner of the premint wallet smart contract configuring the token preminter and one or more premint token spenders to spend preminted tokens from the premint wallet.

At block 230, the operations 200 proceed with the token preminter minting a plurality of tokens to the premint wallet.

At block 240, the operations 200 proceed with receiving, at a token premint spender from the one or more premint token spenders, a request to spend an amount of preminted tokens from the premint wallet.

At block 250, the operations 200 proceed with comparing, by the token premint spender, the requested amount of preminted tokens to a spending allowance defined for the token premint spender.

At block 260, the operations 200 proceed with, based on the comparing indicating that the requested amount is less than the spending allowance defined for the token premint spender, transferring, by the token premint spender, the requested amount of preminted tokens from the premint wallet to a destination wallet on the blockchain.

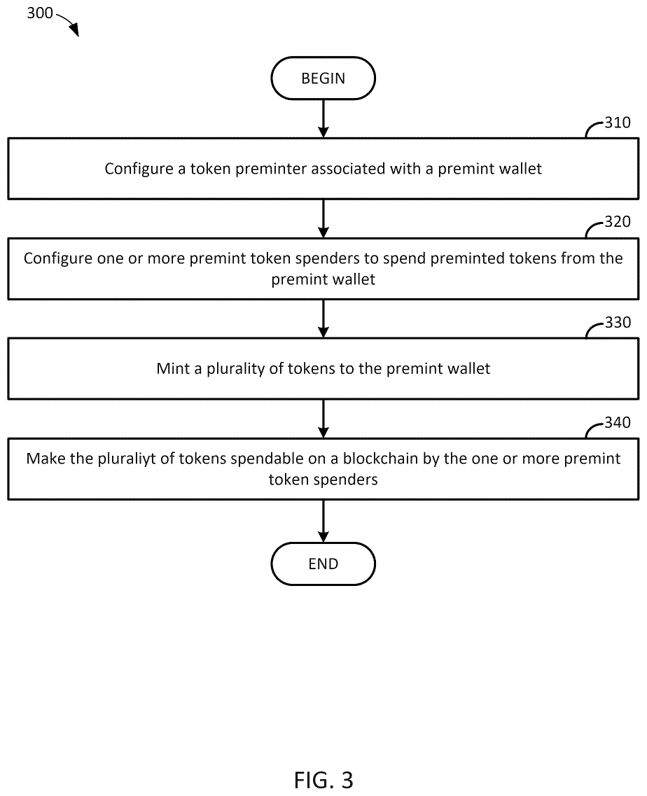

FIG. 3 illustrates example operations 300 for configuring and using a preminter to securely premint tokens on a blockchain, according to aspects of the present disclosure. The operations 300 may be performed, for example, by a token preminter such as the token preminter 120 illustrated in FIG. 1.

As illustrated, the operations 300 begin at block 310 with configuring a token preminter. Generally, the token preminter may be associated with a premint wallet into which preminted tokens are stored.

At block 320, the operations 300 proceed with configuring one or more premint spenders to spend preminted tokens from the premint wallet.

In some aspects, configuring the one or more premint token spenders comprises configuring a token spender controller to spend tokens in the premint wallet using the one or more premint token spenders.

At block 330, the operations 300 proceed with minting a plurality of tokens to the premint wallet.

At block 340, the operations 300 proceed with making the plurality of tokens spendable on a blockchain by the one or more premint token spenders.

In some aspects, configuring the one or more premint token spenders comprises configuring each premint token spender of the one or more premint token spenders with a token spending allowance and a set of addresses to which tokens in the premint wallet can be transferred. In some aspects, the operations 300 further include determining that the token spending allowance for a premint token spender of the one or more premint token spenders has been depleted. Based on a defined amount received from an owner of the token preminter, the token spending allowance for the premint token spender is reset. In some aspects, the set of addresses comprise one or more addresses corresponding to a token reserve balance address controlled by an owner of the plurality of tokens.

In some aspects, the token minter is configured to mint tokens with an unlimited token minting allowance.

In some aspects, the premint wallet comprises a smart contract account defined by a smart contract address.

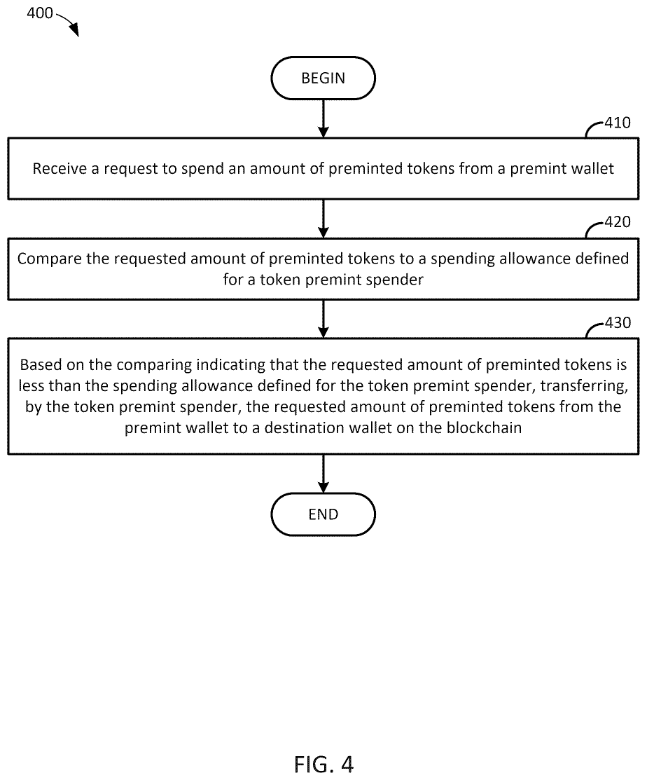

FIG. 4 illustrates example operations 400 for securely spending preminted tokens on a blockchain, according to aspects of the present disclosure. The operations 400 may be performed, for example, by a premint token spender, such as the permit token spender 130 illustrated in FIG. 1.

As illustrated, the operations 400 begin at block 410 with receiving a request to spend an amount of preminted tokens from a premint wallet.

At block 420, the operations 400 proceed with comparing the requested amount of preminted tokens to a spending allowance defined for a token premint spender.

At block 430, the operations 400 proceed with transferring, based on the comparing indicating that the requested amount of preminted tokens is less than the spending allowance defined for the token premint spender, the requested amount of preminted tokens from a premint wallet to a destination wallet on a blockchain.

In some aspects, transferring the requested amount of preminted tokens from the premint wallet to the destination wallet comprises decrementing the spending allowance by the requested amount of preminted tokens.

In some aspects, the destination wallet comprises a wallet selected from a plurality of wallets included in an allowlist of wallets to which the token premint spender can transfer tokens.

In some aspects, the operations 400 further include selecting, based on the comparing indicating that the requested amount of preminted tokens exceeds the spending allowance defined for the token premint spender, a different token premint spender to use in transferring the requested amount of preminted tokens to the destination wallet.

In some aspects, the operations 400 further include based on the comparing indicating that the requested amount of preminted tokens exceeds the spending allowance defined for the token premint spender, transferring a number of tokens corresponding to the spending allowance defined for the token premint spender to the destination wallet, and selecting a different token premint spender to use in transferring a number of tokens corresponding to the difference between the requested amount of preminted tokens and the spending allowance defined for the token premint spender to the destination wallet.

In some aspects, transferring the requested amount of preminted tokens from the premint wallet to the destination wallet comprises invoking a spend function defined in a premint wallet token contract associated with the preminted tokens. The spend function defined in the premint wallet token contract may invoke a transfer function defined in a token contract for minted tokens deployed to the blockchain.

### Example System for Secure Preminting of Tokens on a Blockchain Using Distributed Token Preminting and Spending

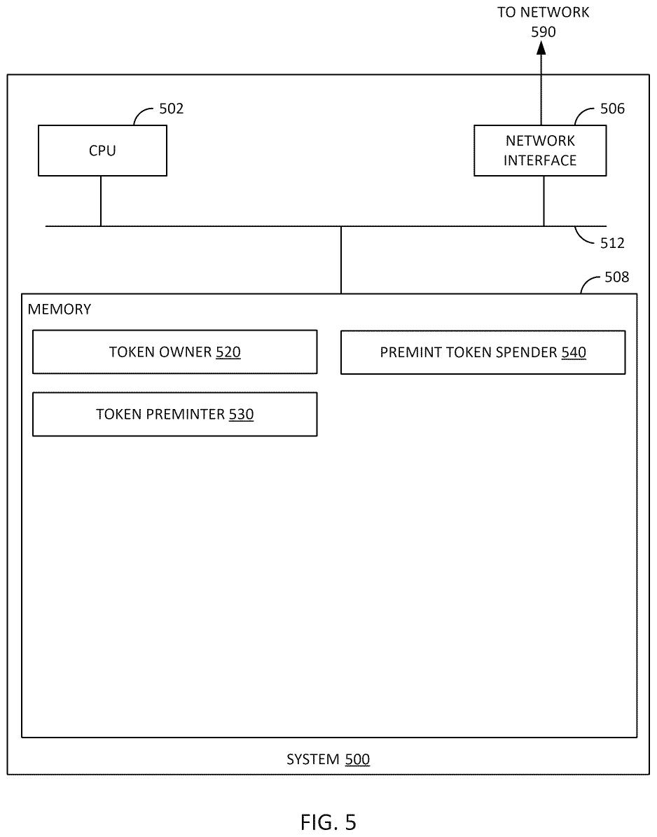

FIG. 5 illustrates an example system 500 configured to perform the methods described herein, including, for example, operations 200 illustrated in FIG. 2, operations 300 illustrated in FIG. 3, and/or operations 400 illustrated in FIG. 4. In some embodiments, system 500 may act as a computing system including one or more of a token owner 110, a token preminter 120, and/or a premint token spender 130 illustrated in FIG. 1.

As shown, system 500 includes a central processing unit (CPU) 502, network interface 506 through which system 500 is connected to network 590 (which may be a local network, an intranet, the internet, or any other group of computing devices communicatively connected to each other), a memory 508, and an interconnect 512. The network interface 506 may be used to receive requests to upgrade bridged tokens on a blockchain to native tokens on the blockchain (e.g., as depicted and described with respect to FIGS. 1 through 4.

CPU 502 may retrieve and execute programming instructions stored in the memory 508. Similarly, the CPU 502 may retrieve and store application data residing in the memory 508. The interconnect 512 transmits programming instructions and application data, among the CPU 502, network interface 506, and memory 508.

CPU 502 is included to be representative of a single CPU, multiple CPUs, a single CPU having multiple processing cores, and the like.

Memory 508 is representative of a volatile memory, such as a random access memory, or a nonvolatile memory, such as nonvolatile random access memory, phase change random access memory, or the like. As shown, memory 508 includes a token owner 520, a token preminter 530, and a premint token spender 540.

The token owner 520 may correspond to the token owner 110 illustrated in FIG. 1. Generally, the token owner 520 owns a smart contract that defines the minting of tokens on the blockchain. To coordinate secure preminting of tokens on a blockchain using distributed token preminting and spending and prevent the compromise of a single role in the distributed system from allowing for the unlimited minting of tokens on the blockchain, the token owner 520 generally configures a premint wallet smart contract associated with the token preminter 530 as a token minter. The premint wallet smart contract may be configured with an infinite allowance so that a supply of tokens can be minted (and, in some aspects, burned) on an as-needed basis. For example, a supply of preminted tokens may be maintained to allow for the issuance of tokens when various triggering events defined by the token owner 520 occur.

The token preminter 530 may correspond to the token preminter 120 illustrated in FIG. 1. Generally, the token preminter 530 allows for the minting and burning of preminted tokens on an as-needed basis. To mint tokens, the token preminter 530 can execute a token minting function on the premint wallet smart contract defining the premint wallet into which preminted tokens are deposited. After the tokens are minted and deposited, the extant balance of tokens in the premint wallet may be updated to reflect the deposit of the newly minted tokens into the premint wallet. Further, the token preminter 530 may configure one or more preminted token spenders 540 to distribute preminted tokens to defined destination wallets on a blockchain. Generally, in configuring the one or more preminted token spenders 540, the token preminter 530 may configure a spender controller and a wallet address associated with the premint token spender 540.

The premint token spender 540 may correspond to the premint token spender 130 illustrated in FIG. 1. Generally, the premint token spender 540 can transfer tokens from a premint wallet to a destination wallet when triggered to execute a token transfer operation. A triggering event for a token transfer operation may, for example, occur when real or virtual assets are deposited and confirmed to have been received by a reserve resource in which real or physical assets backing a token are stored, when specified events such as the completion of a computing task, or the like have occurred. When the triggering event occurs, the premint token spender 540 compares the requested amount of tokens to be spent from the premint wallet to a spending allowance associated with the premint token spender 540. If the requested amount is less than the spending allowance, the premint token spender 540 may invoke a transfer function to spend the requested amount of tokens and effectuate the transfer of these tokens to a specified destination address, which may be an address included on an allowlist of addresses to which the premint token spender 540 is allowed to transfer tokens. If the requested amount exceeds the spending allowance, the premint token spender 540 can take various actions to coordinate the transfer of the requested amount to the destination wallet with one or more other premint token spenders.

### Example Clauses

Implementation details for various aspects of the present disclosure are described in the following numbered clauses.

Clause 1: A processor-implemented method, comprising: configuring a token preminter, the token preminter being associated with a premint wallet into which preminted tokens are stored; configuring one or more premint token spenders to spend preminted tokens from the premint wallet; minting a plurality of tokens to the premint wallet; and making the plurality of tokens spendable on a blockchain by the one or more premint token spenders.

Clause 2: The method of Clause 1, wherein configuring the one or more premint token spenders comprises configuring a token spender controller to spend tokens in the premint wallet using the one or more premint token spenders.

Clause 3: The method of Clause 1 or 2, wherein configuring the one or more premint token spenders comprises configuring each premint token spender of the one or more premint token spenders with a token spending allowance and a set of addresses to which tokens in the premint wallet can be transferred.

Clause 4: The method of Clause 3, further comprising: determining that the token spending allowance for a premint token spender of the one or more premint token spenders has been depleted; and resetting the token spending allowance for the premint token spender based on a defined amount received from an owner of the token preminter.

Clause 5: The method of Clause 3 or 4, wherein the set of addresses comprise one or more addresses corresponding to a token reserve balance address controlled by an owner of the plurality of tokens.

Clause 6: The method of any of Clauses 1 through 5, wherein the token minter is configured to mint tokens with an unlimited token minting allowance.

Clause 7: The method of any of Clauses 1 through 6, wherein the premint wallet comprises a smart contract account defined by a smart contract address.

Clause 8: A processor-implemented method, comprising: receiving a request to spend an amount of preminted tokens from a premint wallet; comparing the requested amount of preminted tokens to a spending allowance defined for a token premint spender; and based on the comparing indicating that the requested amount of preminted tokens is less than the spending allowance defined for the token premint spender, transferring the requested amount of preminted tokens from a premint wallet to a destination wallet on a blockchain.

Clause 9: The method of Clause 8, wherein transferring the requested amount of preminted tokens from the premint wallet to the destination wallet comprises decrementing the spending allowance by the requested amount of preminted tokens.

Clause 10: The method of Clause 8 or 9, wherein the destination wallet comprises a wallet selected from a plurality of wallets included in an allowlist of wallets to which the token premint spender can transfer tokens.

Clause 11: The method of any of Clauses 8 through 10, further comprising: based on the comparing indicating that the requested amount of preminted tokens exceeds the spending allowance defined for the token premint spender, selecting a different token premint spender to use in transferring the requested amount of preminted tokens to the destination wallet.

Clause 12: The method of any of Clauses 8 through 11 further comprising: based on the comparing indicating that the requested amount of preminted tokens exceeds the spending allowance defined for the token premint spender, transferring a number of tokens corresponding to the spending allowance defined for the token premint spender to the destination wallet, and selecting a different token premint spender to use in transferring a number of tokens corresponding to the difference between the requested amount of preminted tokens and the spending allowance defined for the token premint spender to the destination wallet.

Clause 13: The method of any of Clauses 8 through 12, wherein transferring the requested amount of preminted tokens from the premint wallet to the destination wallet comprises invoking a spend function defined in a premint wallet token contract associated with the preminted tokens.

Clause 14: The method of Clause 13, wherein the spend function defined in the premint wallet token contract invokes a transfer function defined in a token contract for minted tokens deployed to the blockchain.

Clause 15: The method of any of Clauses 8 through 14, wherein comparing the requested amount of preminted tokens to a spending allowance defined for a token premint spender comprises identifying the token premint spender from a plurality of token premint spenders having a spending allowance exceeding the requested amount of preminted tokens.

Clause 16: A processor-implemented method, comprising: configuring, by an owner of a token deployed on a blockchain, a premint wallet smart contract associated with a token preminter that generates preminted tokens for the token deployed on the blockchain; configuring, by an owner of the premint wallet smart contract, the token preminter and one or more premint token spenders to spend preminted tokens from the premint wallet; minting, by the token preminter, a plurality of tokens to the premint wallet; receiving, at a premint token spender from the one or more premint token spenders, a request to spend an amount of preminted tokens from the premint wallet; comparing, by the premint token spender, the requested amount of preminted tokens to a spending allowance defined for the token premint spender; and based on the comparing indicating that the requested amount of preminted tokens is less than the spending allowance defined for the token premint spender, transferring, by the token premint spender, the requested amount of preminted tokens from the premint wallet to a destination wallet on a blockchain.

Clause 17: A system, comprising: a memory having executable instructions stored thereon; and a processor configured to execute the executable instructions to perform the operations of any one of Clauses 1 through 16.

Clause 18: A system, comprising: means for performing the operations of any one of Clauses 1 through 16.

Clause 19: A computer-readable medium having instructions stored thereon which, when executed by a processor, performs the operations of any one of Clauses 1 through 16.

### Additional Considerations

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
configuring a token preminter, the token preminter being associated with a premint wallet into which preminted tokens are stored;
configuring one or more premint token spenders to spend preminted tokens from the premint wallet;
minting a plurality of tokens to the premint wallet; and
making the plurality of tokens spendable on a blockchain by the one or more premint token spenders.

2. The method of claim 1, wherein configuring the one or more premint token spenders comprises configuring a token spender controller to spend tokens in the premint wallet using the one or more premint token spenders.

3. The method of claim 1, wherein configuring the one or more premint token spenders comprises configuring each premint token spender of the one or more premint token spenders with a token spending allowance and a set of addresses to which tokens in the premint wallet can be transferred.

4. The method of claim 3, further comprising:
determining that the token spending allowance for a premint token spender of the one or more premint token spenders has been depleted; and
resetting the token spending allowance for the premint token spender based on a defined amount received from an owner of the token preminter.

5. The method of claim 3, wherein the set of addresses comprise one or more addresses corresponding to a token reserve balance address controlled by an owner of the plurality of tokens.

6. The method of claim 1, wherein the token minter is configured to mint tokens with an unlimited token minting allowance.

7. The method of claim 1, wherein the premint wallet comprises a smart contract account defined by a smart contract address.

8. A processor-implemented method, comprising:
receiving a request to spend an amount of preminted tokens from a premint wallet;
comparing the requested amount of preminted tokens to a spending allowance defined for a token premint spender; and
based on the comparing indicating that the requested amount of preminted tokens is less than the spending allowance defined for the token premint spender, transferring the requested amount of preminted tokens from a premint wallet to a destination wallet on a blockchain.

9. The method of claim 8, wherein transferring the requested amount of preminted tokens from the premint wallet to the destination wallet comprises decrementing the spending allowance by the requested amount of preminted tokens.

10. The method of claim 8, wherein the destination wallet comprises a wallet selected from a plurality of wallets included in an allowlist of wallets to which the token premint spender can transfer tokens.

11. The method of claim 8, further comprising: based on the comparing indicating that the requested amount of preminted tokens exceeds the spending allowance defined for the token premint spender, selecting a different token premint spender to use in transferring the requested amount of preminted tokens to the destination wallet.

12. The method of claim 8 further comprising: based on the comparing indicating that the requested amount of preminted tokens exceeds the spending allowance defined for the token premint spender,
transferring a number of tokens corresponding to the spending allowance defined for the token premint spender to the destination wallet, and
selecting a different token premint spender to use in transferring a number of tokens corresponding to the difference between the requested amount of preminted tokens and the spending allowance defined for the token premint spender to the destination wallet.

13. The method of claim 8, wherein transferring the requested amount of preminted tokens from the premint wallet to the destination wallet comprises invoking a spend function defined in a premint wallet token contract associated with the preminted tokens.

14. The method of claim 13, wherein the spend function defined in the premint wallet token contract invokes a transfer function defined in a token contract for minted tokens deployed to the blockchain.

15. The method of claim 8, wherein comparing the requested amount of preminted tokens to a spending allowance defined for a token premint spender comprises identifying the token premint spender from a plurality of token premint spenders having a spending allowance exceeding the requested amount of preminted tokens.

16. A processor-implemented method, comprising:
configuring, by an owner of a token deployed on a blockchain, a premint wallet smart contract associated with a token preminter that generates preminted tokens for the token deployed on the blockchain;
configuring, by an owner of the premint wallet smart contract, the token preminter and one or more premint token spenders to spend preminted tokens from the premint wallet;
minting, by the token preminter, a plurality of tokens to the premint wallet;
receiving, at a premint token spender from the one or more premint token spenders, a request to spend an amount of preminted tokens from the premint wallet;
comparing, by the premint token spender, the requested amount of preminted tokens to a spending allowance defined for the token premint spender; and
based on the comparing indicating that the requested amount of preminted tokens is less than the spending allowance defined for the token premint spender, transferring, by the token premint spender, the requested amount of preminted tokens from the premint wallet to a destination wallet on a blockchain.
